(19) United States
(12) Patent Application Publication
(10) Pub. No.: US 2013/0060608 A1
(43) Pub. Date: Mar. 7, 2013

(54) METHODS AND APPARATUS TO DETERMINE MOBILE DEVICE MARKET SHARE

(71) Applicants: Haitao Lin, Allen, TX (US); Madhusudhan Reddy Alla, Allen, TX (US)

(72) Inventors: Haitao Lin, Allen, TX (US); Madhusudhan Reddy Alla, Allen, TX (US)

(21) Appl. No.: 13/407,523

(22) Filed: Feb. 28, 2012

Related U.S. Application Data
(60) Provisional application No. 61/530,255, filed on Sep. 1, 2011.

(51) Int. Cl. G06Q 30/02

(52) U.S. Cl. 705/7.34; 705/7.29

(57) ABSTRACT

Methods and apparatus to determine mobile device market share are disclosed. An example method includes generating a panel of phone numbers; querying a network register to determine a hardware address associated with a phone number of the panel of phone numbers; associating the hardware address with at least one of a manufacturer or a model of a mobile device; and calculating a mobile device market share based on the association of the hardware address with the at least one of the make or the model of the mobile device.

### RELATED APPLICATION(S)

This patent claims priority from U.S. Provisional Application Ser. No. 61/530,255 entitled “METHODS AND APPARATUS TO DETERMINE MOBILE DEVICE MARKET SHARE” and filed on Sep. 1, 2011. U.S. Provisional Application Ser. No. 61/530,255 is hereby incorporated by reference in its entirety.

### FIELD OF THE DISCLOSURE

This disclosure relates generally to determining market share and, more particularly, to methods and apparatus to determine mobile device market share.

### BACKGROUND

The increasing competition in telecommunication markets has increased the need for competitive performance data that includes market share, subscriber counts, activation metrics, deactivation metrics, phone number porting metrics, etc. Competitive performance data can be used by companies to launch efficient marketing campaigns, to efficiently plan capital investments, for competitive analysis, to select mobile devices to offer, etc. For example, telecommunication market share data (e.g., the number of users using a particular mobile device) in a geographic market can be valuable to a wireless provider to launch effective marketing campaigns, to forecast consumer demand for a mobile device, etc.

More generally, data collection can be used by companies to better understand the structure of their respective markets and, as a result, understand their competitive performance. Understanding competitive performance enables businesses (e.g., mobile device manufacturers, wireless service providers, mobile device retailers, etc.) to modify their products and services to achieve the highest possible efficiency.

To collect data, businesses have relied on sales information from retail and web stores. However, collecting and using this sales information is complex. In some cases, service providers sell the mobile devices used on their network, while in other cases a retailer might sell the mobile device used on the service provider's network. Aggregating the sales information is not easy because gathering complete sales data may require gathering sales information from competitive businesses. Further, some businesses such as, for example, mobile device manufacturers, do not sell mobile devices to end consumers and, therefore, cannot directly gather any retail sales information.

### BRIEF DESCRIPTION OF THE DRAWINGS

FIG. 1 is a block diagram of an example system to determine mobile device market share including a market share determiner.

FIG. 2 illustrates example contents of a report that may be generated by the market share determiner of FIG. 1.

FIG. 3 is a block diagram of the example market share determiner of FIG. 1.

FIG. 4 is a flowchart representative of example machine-readable instructions that may be executed to implement the example market share determiner of FIGS. 1 and 3.

FIG. 5 is a block diagram of an example computer that may execute, for example, the machine-readable instructions of FIG. 4 to implement the example market share determiner of FIGS. 1 and 3.

### DETAILED DESCRIPTION

The increasing competition in telecommunication markets has increased the need for competitive performance data that includes market share, subscriber counts, activation metrics, deactivation metrics, phone number porting metrics, etc. Mobile device manufacturers, retailers, and/or service providers seek to determine competitive performance data such as, for example, how well a particular mobile device is selling in various markets. Such determination may allow the manufacturer, retailer, and/or service provider to make changes to, for example, increase sales. Previously, mobile device sales information was recorded at the time of sale. Because sales information is fragmented (e.g., sales from different businesses may not be shared,) the sales information is of limited scope. Nevertheless, as mobile devices become more prevalent, mobile device manufacturers, retailers, and/or service providers seek to more accurately measure how many and what type of mobile devices are activated and deactivated in any region for any given period of time.

An example system described herein allows for the use of network polling technology to measure mobile device activations by manufacturer and/or model. This enables mobile device manufacturers, retailers, and/or service providers to receive market share information relating to a mobile device by manufacturer, model, service provider region, mobile operating systems, etc.

Mobile devices are identified by a unique hardware address. The usage and/or nomenclature of the hardware address may vary based on one or more factors such as, for example, the type of network providing service to the mobile device. In some examples, an electronic serial number (ESN) is used to identify the mobile device. Additionally or alternatively, any past, present, or future hardware address may be used such as, for example, a Mobile Equipment Identifier (MEID), an International Mobile Equipment Identifier (IMEI), etc. In some examples, the hardware address contains identifiers of a manufacturer (e.g., a make) and/or a model of the mobile device. For example, an ESN is a thirty-two bit number, with the first fourteen bits (e.g., a first section) reserved to identify the manufacturer of the mobile device. The remaining bits (e.g., a second section) of the hardware address identify, for example, the model of the mobile device.

The hardware addresses of active mobile devices on a wireless network are stored in core network elements. In the examples illustrated below, a Home Location Register (HLR) of the core network stores information regarding mobile devices on the network including, for example, a phone number associated with the mobile device, the hardware address of the mobile device, etc. The information associated with each mobile device can, therefore, be queried via the HLR. For example, a request can be sent to the Home Location Register (HLR) in the core network to get model level information about a specific mobile device (e.g., a device associated with a particular phone number). The mobile device information can then be used to determine mobile device activations, deactivations, purchases, etc.

In some examples, a method of determining market share of a mobile device includes creating a panel of mobile phone numbers using a number block allotment created by a regulator in that market. In some examples, the panel of mobile phone numbers is selected at random. An example method further includes sending a signaling query to a service provider network to retrieve a hardware address associated with each phone number included in the panel of mobile phone numbers. In some examples, the signaling query is sent to a network register of the service provider network. An example method further includes associating each retrieved hardware address with a manufacturer and/or a model name of the mobile device. An example method further includes calculating a market share for the manufacturer and/or model information based on the manufacturer and/or model information.

In some examples, the method is performed periodically, thereby allowing calculation of changes in market share. Performing periodic retrievals of hardware address information associated with respective ones of the panel of mobile phone numbers enables identification of particular scenarios related to mobile devices such as, for example, when a new subscriber (e.g., a customer) acquires service after having ported a phone number from a previous carrier, when a new subscriber acquires service without having ported a phone number from a previous carrier, when an existing subscriber switches to a different mobile device, etc.

Such an example system enables mobile device manufactures to view data regarding how mobile devices produced by a competitor are selling over time by market and/or by service provider. Further, the example system allows service providers to track how their mobile device launches are performing as well as gather insight into popular models of their competitors that are driving growth. In some examples, the system allows tracking of operating systems (e.g., Android, iOS, Windows Mobile, etc.) and, thus, can track how the operating systems are performing as the mobile device market grows and shrinks Further still, the example system allows retailers to identify popular models in each region to, for example, better tailor their mobile device offerings.

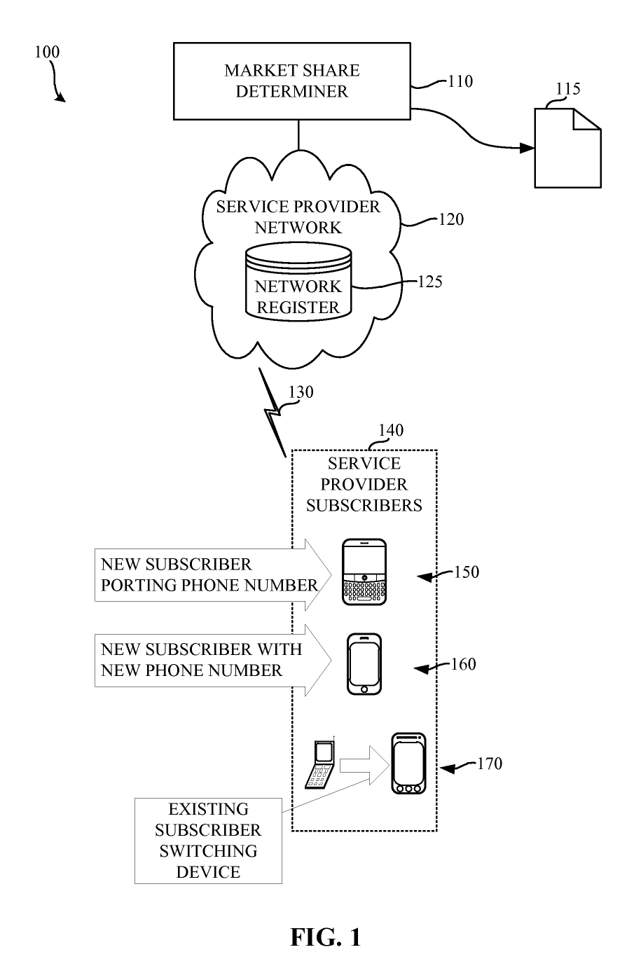

FIG. 1 is a block diagram of an example system 100 to determine mobile device market share. The example system 100 includes a market share determiner 110, a service provider network 120, and service provider subscribers 140. The service provider network 120 contains a network register 125 and communicates with the service provider subscribers 140 via a wireless communication link 130. Further, three example subscribers 150, 160, and 170 are shown in FIG. 1.

The market share determiner 110 of the illustrated example includes a server that communicates with the service provider network 120 via a network such as, for example, the Internet. However, the market share determiner 110 may be any other type of computing device such as, for example, a personal computer, a laptop, a cellular device, etc. In the illustrated example, the market share determiner 110 is located outside of the service provider network 120. However, in some examples, the market share determiner 110 may be integrated into the service provider network 120. In the illustrated example, the market share determiner 110 periodically polls the service provider network 120 to identify hardware addresses of mobile devices associated with a panel of mobile device phone numbers.

The market share determiner 110 of the illustrated example generates a report 115. The report 115 of the illustrated example includes information identifying, for example, market information related to the launch of a new mobile device, market information related to the number of mobile devices used in a given geographic area and/or region, competitive performance data related to the number of subscribers who port their number from one service provider to another, etc. In the illustrated example, the report 115 is generated as an electronic document, such as, for example, a Microsoft Word document, a portable document format (PDF) document, a Microsoft Excel document, a comma separated value (CSV) document, a Hypertext Markup Language (HTML) document (e.g., a webpage), etc. In some examples, the report 115 may be a printed document.

The service provider network 120 of the illustrated example is a wireless network provider such as, for example, a carrier. In the illustrated example, a single service provider network is shown. However, in some examples, multiple service provider networks 120 are used. For example, a service provider may host multiple networks divided by, for example, region. Further, in some examples, multiple service providers exist. For example, multiple service providers might compete in multiple and/or overlapping regions.

The network register 125 of the illustrated example is a Home Location Register (HLR). However, any other type of network register 125 may additionally or alternatively be used such as, for example, a visiting location register (VLR). The network register 125 is a database that stores information associated with each subscriber of the service provider 120. In the illustrated example, the network register 125 stores information such as a mobile phone number, a hardware address associated with a mobile device, and an association of the hardware address and the mobile phone number.

In the illustrated example, the market share determiner 110 queries the network register 125 for each mobile phone number within a panel of mobile phone numbers. In some examples, the query is transmitted as a single query for the panel of mobile phone numbers, while in some examples a single query is transmitted for each mobile phone number within the panel of mobile phone numbers. In some other systems, the mobile device is queried instead of the network register 125. In examples where the mobile device is queried, problems may be encountered such as, for example, the query may not reach the mobile device, the mobile device may not respond, the mobile device may be powered off, etc.

Querying the network register 125 has several benefits such as, for example, enhanced reliability, enhanced performance, and/or enhanced accuracy. In some examples, querying the network register 125 provides enhanced reliability because a single device is queried, thus avoiding the problem of mobile devices not responding to queries. Because the single device is queried, multiple hardware addresses can be retrieved at once, thus leading to enhanced performance and a lower communications load on the service provider network 120. When the communications load on the service provider network 120 is lowered, the size of the panel of mobile phone numbers can be increased. An increased panel size may lead to greater accuracy in calculations because lower projection factors are required.

The wireless communication link 130 of the illustrated example is implemented as a cellular communication link. In the illustrated example, the wireless communication link 130 is implemented by a code division multiple access (CDMA) protocol. However, any other past, present, or future communications protocol may additionally or alternatively be used such as, for example, a global system for mobile communications (GSM), WiMax, long term evolution (LTE), etc. Further, while the wireless communication link 130 of the illustrated example is a cellular communication link, the wireless communication link 130 may additionally or alternatively be any other past, present, or future type of communications link such as, for example, a Bluetooth communication link, an Institute of Electrical and Electronics Engineers 802.15.4 (ZigBee) link, a WiFi link, etc.

In the example shown in FIG. 1, three subscribers (e.g., customers, etc) 150, 160, and 170 are shown. The first example subscriber 150 illustrates an example scenario where the subscriber acquires service with the service provider and ports a phone number associated with a previous service provider. By identifying the service provider from the phone number 150, the market share determiner 110 can identify when a number is ported from one service provider to another. Further, the market share determiner 110, by identifying the hardware address associated with the phone number, differentiates between subscribers that switched and kept the same mobile device and subscribers that switched and are now using a new mobile device.

The second example subscriber 160 illustrates an example where the subscriber acquires service with the service provider and establishes a new phone number (e.g., no previous phone number was ported). The market share determiner 110 identifies the new subscriber by determining that the phone number associated with the subscriber was not previously associated with a mobile device.

The third example subscriber 170 illustrates an example where an existing subscriber switches from a first mobile device to a second mobile device. In some examples, the mobile device was switched due to an upgrade, a replacement, etc. The market share determiner 110 identifies subscribers that switched devices by determining that the phone number associated was previously associated with a hardware address other than the hardware address presently associated with the phone number.

While in the illustrated example three subscribers are shown illustrating three scenarios identified by the market share determiner 110, any other scenario may additionally or alternatively be identified by the market share determiner 110. For example, the market share determiner 110 may identify when a subscriber has discontinued service, when a subscriber has switched to a new service provider only to later switch back to a previous service provider (e.g., a win-back), etc.

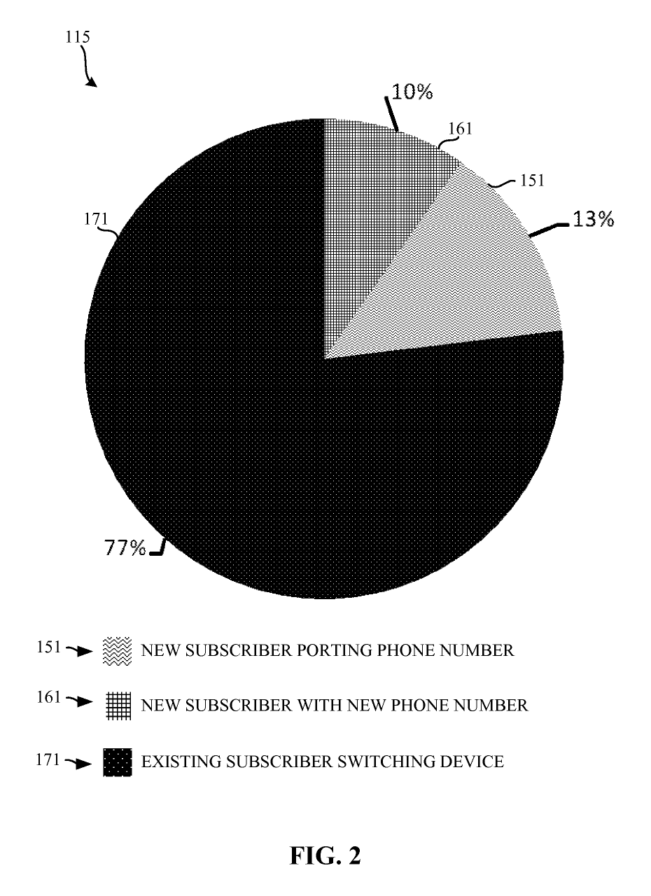

FIG. 2 illustrates example contents of the report 115 of FIG. 1 that may be generated by the market share determiner 110 of FIG. 1. The example report 115 illustrates competitive performance data for a scenario where the service provider has launched a new model mobile device and seeks to determine the effectiveness of the new product launch. In the illustrated example, the example report 115 shows that thirteen percent of the subscribers using the newly launched mobile device are new subscribers that ported their phone number from a previous service provider 151. In the illustrated example, ten percent of the subscribers using the newly launched mobile device were new subscribers that are not associated with a previous service provider 161. In the illustrated example, seventy-seven percent of the subscribers using the newly launched mobile device are existing subscribers that switched to the newly launched mobile device 171. Of course, any other percentages may additionally or alternatively be used. Further, while in the illustrated example the report 115 is shown as a pie chart, any other method of presenting competitive performance data may additionally or alternatively be used, such as, for example, bar graphs, textual representations (e.g., a written description of the results), tabular representations, etc.

While in the illustrated example, the report 115 illustrates competitive performance data related to the scenario where the service provider has launched the new model mobile device, the report 115 may additionally or alternatively illustrate any other competitive performance data. For example, the report 115 may illustrate competitive performance data related to market share for a particular mobile device operating system (e.g., Android, iOS, etc.), market share for a particular make and/or model of mobile device, market share for a service provider, etc. Further still, while in the illustrated example, the report 115 illustrates competitive performance data related to an event (e.g., a launch of a new product), the report 115 may additionally or alternatively illustrate competitive performance data based on, for example, a time period, service provider, region, etc.

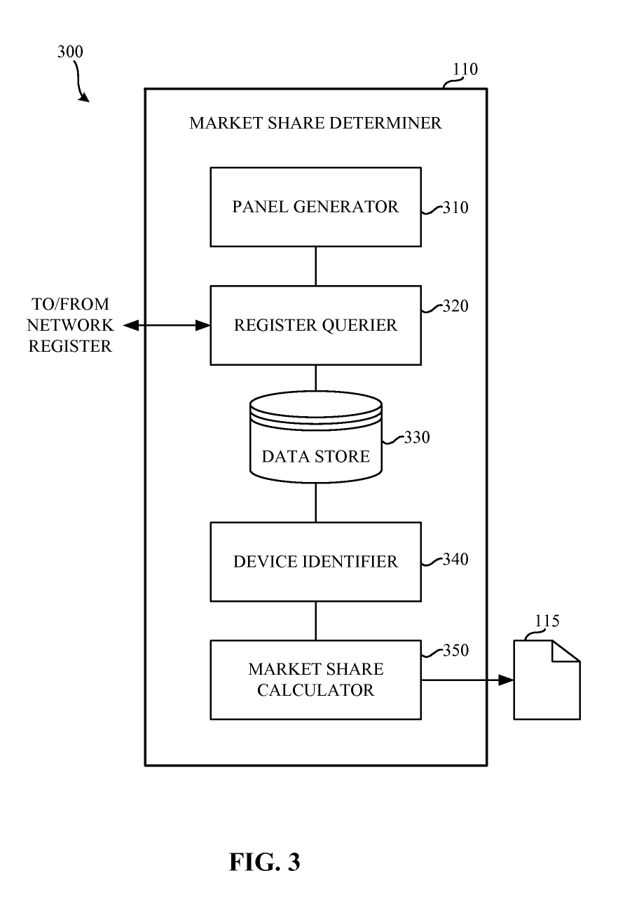

FIG. 3 is a block diagram 300 of the example market share determiner 110 of FIG. 1. The example market share determiner 110 of FIG. 3 includes a panel generator 310, a register querier 320, a data store 330, a device identifier 340, and a market share calculator 350.

The panel generator 310 of the illustrated example of FIG. 3 is implemented by a processor executing instructions but it could, alternatively, be implemented by an application specific integrated circuit (ASIC), digital signal processor (DSP), field programmable gate array (FPGA), or other circuitry. In the example of FIG. 3, the panel generator 310 generates a panel of mobile phone numbers. In the illustrated example, the panel of mobile phone numbers is created at random using a number block allotment created by a regulator in the market (e.g., a government agency, a service provider, etc.). For example, the regulator might allocate ten thousand mobile phone numbers for the market. In such an example, the panel of mobile phone numbers might represent one thousand randomly selected mobile phone numbers associated with the market. In some examples, the phone numbers allotted by the regulator in the market are identified by one or more zip codes associated with a geographic area and/or region such as, for example, a city and its surrounding neighborhoods. While in the illustrated example the panel of mobile phone numbers includes one thousand phone numbers, any other number of mobile phone numbers may additionally or alternatively be used. Further, the panel of mobile phone numbers might not be selected at random. For example, the panel might be selected by using the first thousand mobile phone numbers associated with the market.

The register querier 320 of the illustrated example FIG. 3 is implemented by a processor executing instructions but could, alternatively, be implemented by an ASIC, DSP, FPGA, or other circuitry. In the example of FIG. 3, the register querier 320 queries the service provider network 120 based on the panel of mobile phone numbers. In the illustrated example, the register querier 320 queries the network register 125 of the service provider network 120. However, the register querier 320 may additionally or alternatively query a network device other than the network register 125 such as, for example, a mobile device associated with a phone number of the panel of mobile phone numbers. When querying the service provider network 120, the register querier 320 of the illustrated example retrieves a hardware address associated with each phone number of the panel of mobile phone numbers. The register querier 320 then stores the retrieved hardware address and phone number in the data store 330.

In the illustrated example, the register querier 320 periodically queries the service provider network 120. For example, the register querier 320 queries the service provider network 120 on a monthly basis. However, any other period for querying the service provider network 120 may additionally or alternatively be used such as, for example, daily, weekly, quarterly, yearly, etc. Further, the register querier 320 may query the service provider network 120 on an aperiodic or event-driven basis such as, for example, upon the launch of a new mobile device, the start of a marketing campaign, a change in the price of a service provided by the service provider, etc.

The data store 330 of the illustrated example of FIG. 3 may be any device for storing data such as, for example, flash memory, magnetic media, optical media, etc. Furthermore, the data stored in the data store 330 may be in any data format such as, for example, binary data, comma delimited data, tab delimited data, structured query language (SQL) structures, etc. While in the illustrated example the data store 330 is illustrated as a single database, the data store 330 may be implemented by multiple databases.

The device identifier 340 of the illustrated example FIG. 3 is implemented by a processor executing instructions but could, alternatively, be implemented by an ASIC, DSP, FPGA, or other circuitry. In the example of FIG. 3, the device identifier 340 associates the hardware address stored in the data store 330 with a manufacturer and/or model of the mobile device. As described above, the hardware address in some examples is an electronic serial number (ESN). An ESN is a thirty-two bit number, with a first section (fourteen bits) reserved to identify the manufacturer of the mobile device, a second section to identify the model of the mobile device, and a third section to uniquely identify the mobile device. While in the illustrated example an ESN is used as the hardware address, any other type of hardware address may additionally or alternatively be used. For example, the hardware address may be a Mobile Equipment Identifier (MEID), an International Mobile Equipment Identifier (IMEI), etc.

In the illustrated example the hardware address is broken down into three sections, each identifying different information associated with the mobile device. However, any other number of sections or method of identifying a manufacturer and/or model of a mobile device may additionally or alternatively be used. Further, while in the illustrated example the hardware address includes three sections, these sections may be in any order. In the illustrated example, a first section of the hardware identifier is reserved for a manufacturer identifier. In the illustrated example, the device identifier 340 is to associate the first section of the hardware address with a manufacturer of the mobile device (e.g., Apple®, Motorola®, HTC™, etc.) and store the association in the data store 330. A second section of the hardware identifier is reserved for a model identifier. The device identifier 340 is further to associate the second section of the hardware address with a model of the mobile device (e.g., iPhone®, Droid, EVO™ 3D, etc.). In some examples, a third section identifies the particular mobile device that is being addressed.

The market share calculator 350 of the illustrated example FIG. 3 is implemented by a processor executing instructions but could, alternatively, be implemented by an ASIC, DSP, FPGA, or other circuitry. In the example of FIG. 3, the market share calculator 350 creates projections of the market share based on the association information generated by the device identifier 340. The projections may, for example, extrapolate the association information representative of the panel of mobile phone numbers to, for example, a representation of a larger number of subscribers. The representation may be, for example a representation of subscribers in a region, subscribers associated with a particular carrier, subscribers using a particular mobile device, etc. Further, the market share calculator 350 of the illustrated example generates the report 115 shown in FIG. 1 and illustrated in FIG. 2.

While an example manner of implementing the market share determiner 110 of FIG. 1 has been illustrated in FIG. 3, one or more of the elements, processes and/or devices illustrated in FIG. 3 may be combined, divided, re-arranged, omitted, eliminated and/or implemented in any other way. Further, the example panel generator 310, the example register querier 320, the example data store 330, the example device identifier 340, the example market share calculator 350, and/or, more generally, the example market share determiner 110 of FIGS. 1 and 3 may be implemented by hardware, software, firmware and/or any combination of hardware, software and/or firmware. Thus, for example, any of the example panel generator 310, the example register querier 320, the example data store 330, the example device identifier 340, the example market share calculator 350, and/or, more generally, the example market share determiner 110 of FIGS. 1 and 3 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the example panel generator 310, the example register querier 320, the example data store 330, the example device identifier 340, and/or the example market share calculator 350 are hereby expressly defined to include a computer-readable medium such as a memory, DVD, CD, etc. storing the software and/or firmware. Further still, the example market share determiner 110 of FIGS. 1 and 3 may include one or more elements, processes and/or devices in addition to, or instead of, those illustrated in FIG. 3, and/or may include more than one of any or all of the illustrated elements, processes and devices.

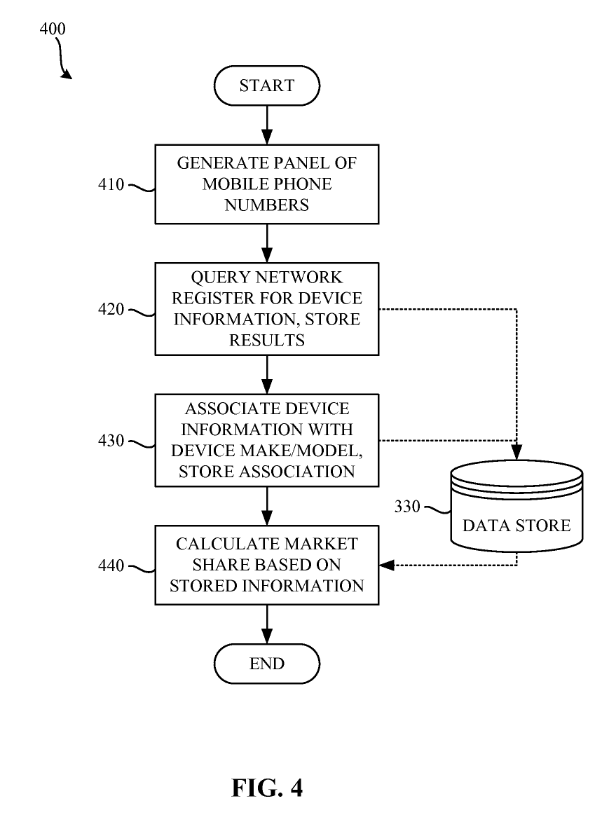

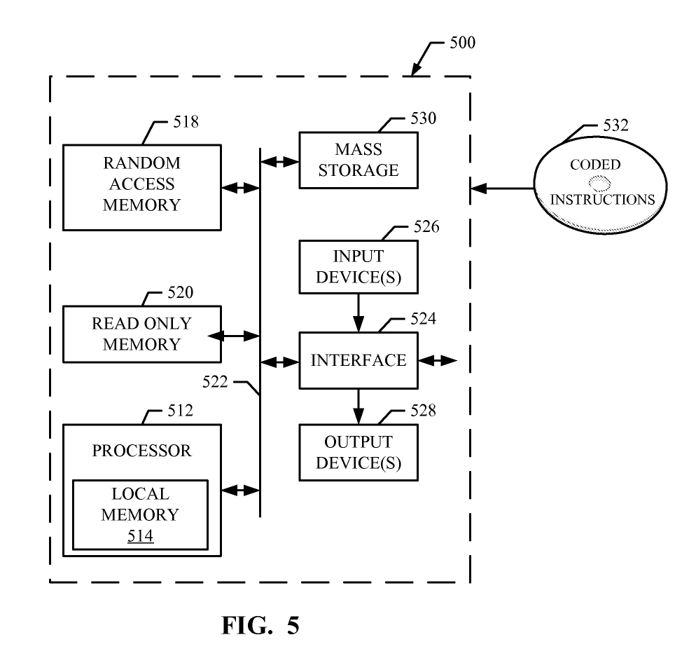

A flowchart 400 representative of example machine-readable instructions for implementing the market share determiner 110 of FIGS. 1 and 3 is shown in FIG. 4. In this example, the machine-readable instructions comprise a program for execution by a processor such as the processor 512 shown in the example computer 500 discussed below in connection with FIG. 5. The program may be embodied in software stored on a computer-readable medium such as a CD-ROM, a floppy disk, a hard drive, a digital versatile disk (DVD), or a memory associated with the processor 512, but the entire program and/or parts thereof could alternatively be executed by a device other than the processor 512 and/or embodied in firmware or dedicated hardware. Further, although the example program is described with reference to the flowchart 400 illustrated in FIG. 4, many other methods of implementing the example market share determiner 110 may alternatively be used. For example, the order of execution of the blocks may be changed, and/or some of the blocks described may be changed, eliminated, or combined.

As mentioned above, the example program of FIG. 4 may be implemented using coded instructions (e.g., computer-readable instructions) stored on a tangible computer-readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer-readable medium is expressly defined to include any type of computer-readable storage and to exclude propagating signals. Additionally or alternatively, the example process of FIG. 4 may be implemented using coded instructions (e.g., computer-readable instructions) stored on a non-transitory computer-readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer-readable medium is expressly defined to include any type of computer-readable medium and to exclude propagating signals.

The program of FIG. 4 begins at block 410 when the panel generator 310 generates a panel of mobile phone numbers 310 (block 410). The panel of mobile phone numbers of the illustrated example is created by selecting, at random, a plurality of mobile phone numbers using the number block allotment created by a regulator (e.g., a government agency, a service provider, etc.) in a market (e.g., a city and surrounding neighborhoods, a state, a nation, a global region, etc.). For each number in the panel of mobile phone numbers, the register querier 320 queries the service provider network 120 for device information and stores the results in the data store 330 (block 420). In the illustrated example, the retrieved device information includes hardware addresses associated with respective mobile phone numbers of the panel of mobile phone numbers. However, in some examples, the device information includes other information related to the mobile device associated with the mobile phone number such as, for example, services provided to the mobile device, information related to the subscriber, additional mobile phone numbers associated with the subscriber, etc. In the illustrated example, the register querier 320 queries the network register 125. However, any other network device may additionally or alternatively be queried, such as, for example, an authentication center (AUC), a mobile switching center (MSC), etc. The device identifier then associates the retrieved hardware addresses with at least one of a manufacturer and model of the mobile device (block 430). The market share calculator 350 then calculates market share information by using projection factors (block 440).

FIG. 5 is a block diagram of an example computer 500 capable of executing the instructions of FIG. 4 to implement the market share determiner 110 of FIGS. 1 and 3. The computer 500 can be, for example, a server, a personal computer, an Internet appliance, or any other type of computing device.

The system 500 of the instant example includes a processor 512. For example, the processor 512 can be implemented by one or more Intel® microprocessors from the Pentium® family, the Itanium® family or the XScale® family. Of course, other processors from other families are also appropriate.

The processor 512 is in communication with a main memory 514 including a volatile memory 518 and a non-volatile memory 520 via a bus 522. The volatile memory 518 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 520 may be implemented by flash memory and/or any other desired type of memory device. Access to the main memory 514 is typically controlled by a memory controller (not shown).

The computer 500 also includes an interface circuit 524. The interface circuit 524 may be implemented by any type of interface standard, such as an Ethernet interface, a universal serial bus (USB), and/or a PCI express interface.

One or more input devices 526 are connected to the interface circuit 524. The input device(s) 526 permit a user to enter data and commands into the processor 512. The input device(s) can be implemented by, for example, a keyboard, a mouse, a touchscreen, a track-pad, a trackball, isopoint and/or a voice recognition system.

One or more output devices 528 are also connected to the interface circuit 524. The output devices 528 can be implemented, for example, by display devices (e.g., a liquid crystal display, a cathode ray tube display (CRT), a printer and/or speakers). The interface circuit 524, thus, typically includes a graphics driver card.

The interface circuit 524 also includes a communication device (e.g., the register querier 320) such as a modem or network interface card to facilitate exchange of data with external computers via a network (e.g., an Ethernet connection, a digital subscriber line (DSL), a telephone line, coaxial cable, a cellular telephone system, etc.).

The computer 500 also includes one or more mass storage devices 530 for storing software and data. Examples of such mass storage devices 530 include floppy disk drives, hard drive disks, compact disk drives and digital versatile disk (DVD) drives. The mass storage device 530 may implement the data store 330.

The coded instructions 532 of FIG. 4 may be stored in the mass storage device 530, in the volatile memory 518, in the non-volatile memory 520, and/or on a removable storage medium such as a CD or DVD.

From the foregoing, it will be appreciated that the above disclosed methods, apparatus and articles of manufacture facilitate the determination of market share of a mobile device.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method of determining mobile device market share, the method comprising:
generating a panel of phone numbers;
querying a network register to determine a hardware address associated with a phone number of the panel of phone numbers;
associating the hardware address with at least one of a manufacturer or a model of a mobile device; and
calculating a mobile device market share based on the association of the hardware address with the at least one of the make or the model of the mobile device.

2. The method as described in claim 1, wherein generating the panel of phone numbers is performed via random block allotment.

3. The method as descried in claim 1, wherein the panel of phone numbers represents phone numbers of a geographic area.

4. The method as described in claim 1, wherein the network register is a Home Location Register.

5. The method as described in claim 1, wherein the network register is a Visiting Location Register.

6. The method as described in claim 1, wherein querying the network register retrieves multiple hardware addresses associated with multiple respective phone numbers of the panel of phone numbers.

7. The method as described in claim 1, wherein a first section of the hardware address is associated with the manufacturer of the mobile device.

8. The method as described in claim 7, wherein a second section of the hardware address is associated with the model of the mobile device.

9. An apparatus to determine mobile device market share, the apparatus comprising:
a panel generator to generate a panel of mobile phone numbers;
a register querier to query a service provider network for a hardware address associated with a phone number of the panel of mobile phone numbers;
a device identifier to associate the hardware addresses with at least one of a manufacturer or a model of a mobile device; and
a market share calculator to create a market share projection based on the association of the hardware address with at least one of the manufacturer and the model of the mobile device.

10. The apparatus as described in claim 9, wherein the panel generator is to generate the panel of mobile phone numbers based on a random block allotment.

11. The apparatus as described in claim 9, wherein the register querier is to query a network register of the service provider network.

12. The apparatus as described in claim 11, wherein the network register is a Home Location Register.

13. The apparatus as described in claim 11, wherein the network register is a Visiting Location Register.

14. The apparatus as described in claim 9, wherein the hardware addresses are Electronic Serial Numbers.

15. The apparatus as described in claim 9, wherein a first section of at least one of the hardware addresses is reserved for a manufacturer identifier.

16. The apparatus as described in claim 15, wherein a second section of the at least one of the hardware addresses is reserved for a model identifier.

17. The apparatus as described in claim 9, wherein the register querier is to periodically query the service provider network.

18. The apparatus as described in claim 17, wherein the register querier is to query the service provider on a monthly basis.

19. A tangible machine-readable medium storing instructions, which when executed, cause a machine to at least:
generate a panel of phone numbers;
query a network register to determine a hardware address associated with a phone number of the panel of phone numbers;
associate the hardware address with at least one of a manufacturer or a model of a mobile device; and
calculate a mobile device market share based on the association of the hardware address with the at least one of the make or the model of the mobile device.

20. The machine-readable medium as described in claim 19, wherein generating the panel of phone numbers is performed via random block allotment.

21. The machine-readable medium as descried in claim 19, wherein the panel of phone numbers represents phone numbers of a geographic area.

22. The machine-readable medium as described in claim 19, wherein the network register is a Home Location Register.

23. The machine-readable medium as described in claim 19, wherein the network register is a Visiting Location Register.

24. The machine-readable medium as described in claim 19, wherein querying the network register retrieves multiple hardware addresses associated with multiple respective phone numbers of the panel of phone numbers.

25. The machine-readable medium as described in claim 19, wherein a first section of the hardware address is associated with the manufacturer of the mobile device.

26. The machine-readable medium as described in claim 25, wherein a second section of the hardware address is associated with the model of the mobile device.
